(19) United States
(12) Patent Application Publication
(10) Pub. No.: US 2003/0138306 A1
(43) Pub. Date: Jul. 24, 2003

(54) Self-drilling insert

(76) Inventor: Thomas Campbell Wallace, Glasgow (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/182,026

(22) PCT Filed: Jan. 19, 2001
(86) PCT No.: PCT/GB01/00198

(30) Foreign Application Priority Data
Jan. 21, 2000 (GB) 0001284.9

(51) Int. Cl. F16B 13/04

(52) U.S. Cl. 411/29

(57) ABSTRACT

A fixing for repairing a hole in a wall of frangible material, the fixing having a body which is provided with fins having cutting edges and which extend laterally from the body for reaming the hole in the wall. The fixing includes means for engaging a tool for rotating the fixing and a generally axial passageway in the body for receiving a screw.

The present invention relates to a fixing for repairing an existing hole in a wall of frangible material and to a method of repairing the hole.

It is common practice to fix items, for example toiler-roll holders and shelves to walls. This usually involves drilling a hole in the wall and securing the item thereto using wall fixings and screws. In the case of a wall of frangible material such as plasterboard the fixing and screw can often become loose over lime due to a slight enlargement of the hole. In order to remedy this a fresh hole would have to be drilled and the present invention is directed to providing a fixing to overcome this problem.

According to the present invention there is provided a fixing having a body, a cutting edge extending laterally from the body for reaming a hole in a wall of material, said body having means for engaging a tool for rotating the fixing, and a generally axial recess in the body for receiving a screw.

Preferably, the fixing has at least two fins projecting laterally from the body, each fin having a cutting edge for reaming the hole in the wall.

Preferably, the fins converge to a leading end of the body.

Preferably, the fins extend longitudinally of the body and each fin has a forward cutting portion, a mid reaming portion and a rear portion.

Preferably, the body has means for resisting rotation of the fixing once fully inserted into the wall.

Preferably, the resisting means is the rear portion of the fins.

Preferably, the fixing has a longitudinal recess which, in use, forms with the reamed portion of the hole of the wall a passageway at least one end of which is open for receiving a filler material.

Preferably, the fins, the body and said reamed portion of the hole of the wall define said passageway for receiving the filler material.

In some cases the filler material has adhesive properties and bonds with the material of the wall.

Typically, the filler material is a non-shrinking curable polymer, for example PLASTIC WOOD™ or POLYFILLA™.

Preferably, the forward cutting portion, mid reaming portion and rear portion taper towards the leading end of the fixing.

Preferably, the forward cutting portion, mid reaming portion and trailing portion have a cutting edge.

Preferably, the sharpness of the cutting edge of the cutting portion is defined by an angle of between 15° and 45° with an opposing face of the cutting portion.

Preferably, the sharpness of the cutting edge of the mid reaming portion and rear portion is each defined by an angle of between 30° and 60° with an opposing face of the mid reaming portion and rear portion respectively.

Preferably, the gradient of the taper of the rear portion is greater than the gradient of the taper of the mid reaming portion.

Preferably, the fixing has an anchoring member at a junction of the forward cutting portion and the mid reaming portion.

Preferably, the anchoring member is a skirt extending outwardly from the body and spanning between the fins at the junction of the forward cutting portion and the mid reaming portion.

Preferably, the skirt has a periphery which falls short of the cutting edge of the cutting portion.

Optionally, the fixing has a stop member depending from the fins at the rear portion remote from the mid reaming portion.

Preferably, the stop member is an annular shaped skirt extending outwardly from the fins. On inserting the fixing into a wall the skirt prevents further penetration of the fixing.

Typically, the diameter of the fixing is in the range of 10 mm to 50 mm. The larger the diameter the more fins are desirable to stabilise the fixing and prevent rotation within the wall. For smaller diameters of the fixing, fewer fins are preferred both for stability and to provide a passageway large enough to allow filler material to be injected into the passageway.

Typically, the wall of material is a wall of frangible material, for example plasterboard and the fixing can be of metal such as zinc or zinc alloy or a composite material, for example glass filled nylon.

Optionally, the filler material is dispensed through a nozzle of a corresponding cross sectional shape to that of the passageway for ease of injection of the filler material into the passageway.

According to another aspect of the invention, there is provided a method of repairing a hole in a wall of frangible material comprising the steps of, inserting the fixing into the hole to a depth approaching that is of the cutting portion 12, continuing to insert the fixing into the hole up to a junction of the mid reaming portion and rear portion by applying pressure to the fixing in the direction of the hole while at the same time rotating the fixing, hammering the rear portion of the fixing into the wall and injecting filler material into the passageway.

An embodiment of the invention will now be described by way of example which reference to the accompanying drawings in which:

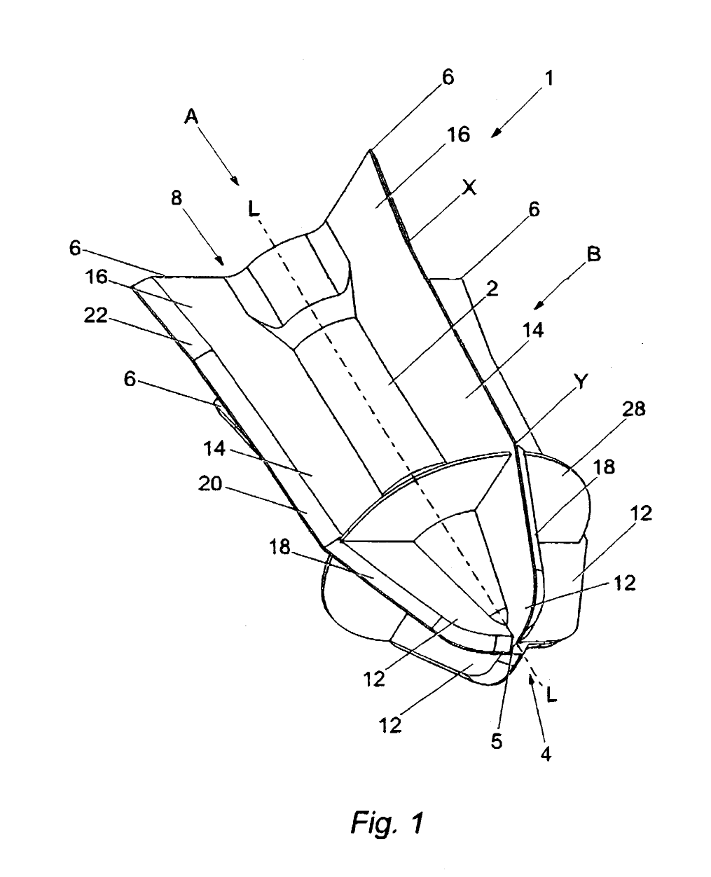

FIG. 1 is a perspective view from the front and above of a fixing according to the present invention,

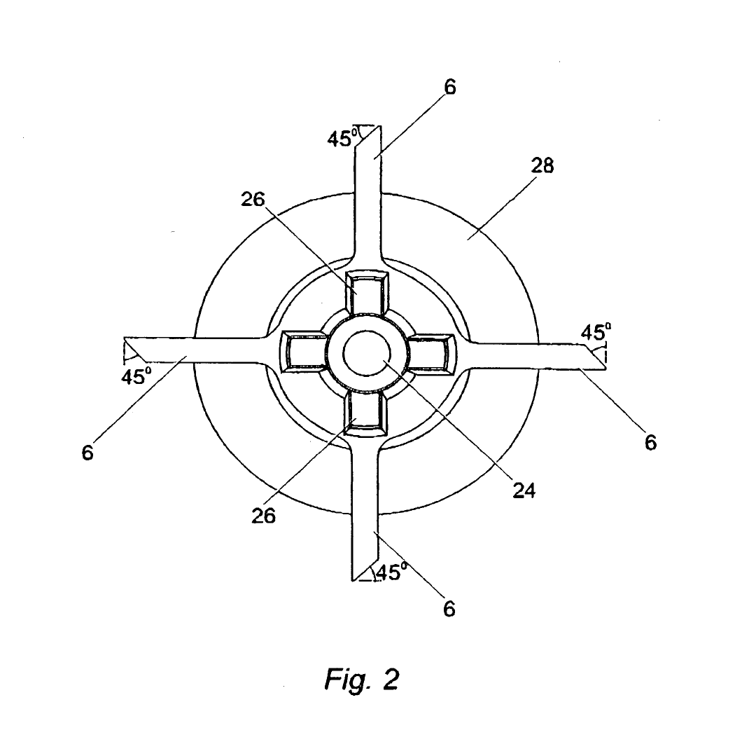

FIG. 2 is a rear view of the fixing of FIG. 1;

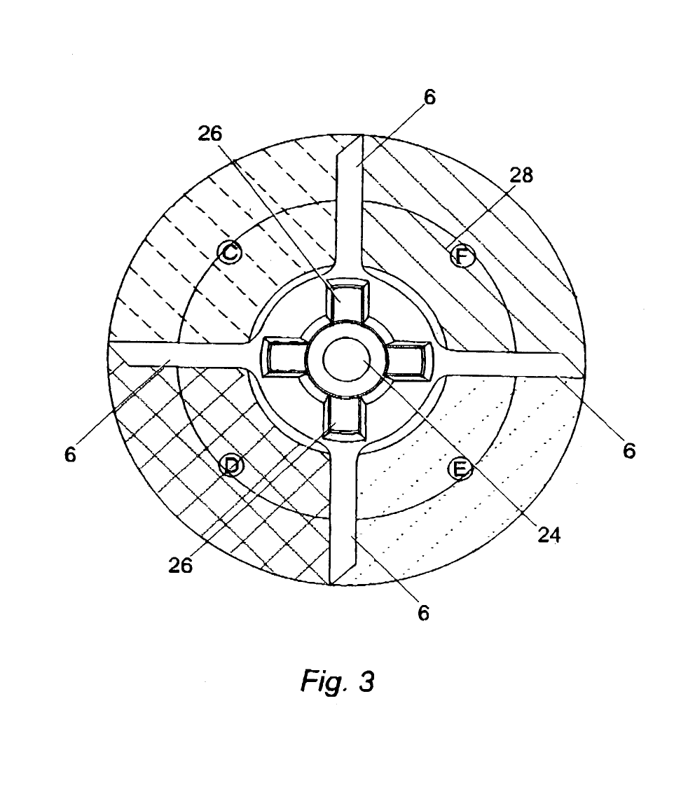

FIG. 3 is a rear view of the fixing of FIG. 1 embedded in a wall of frangible material;

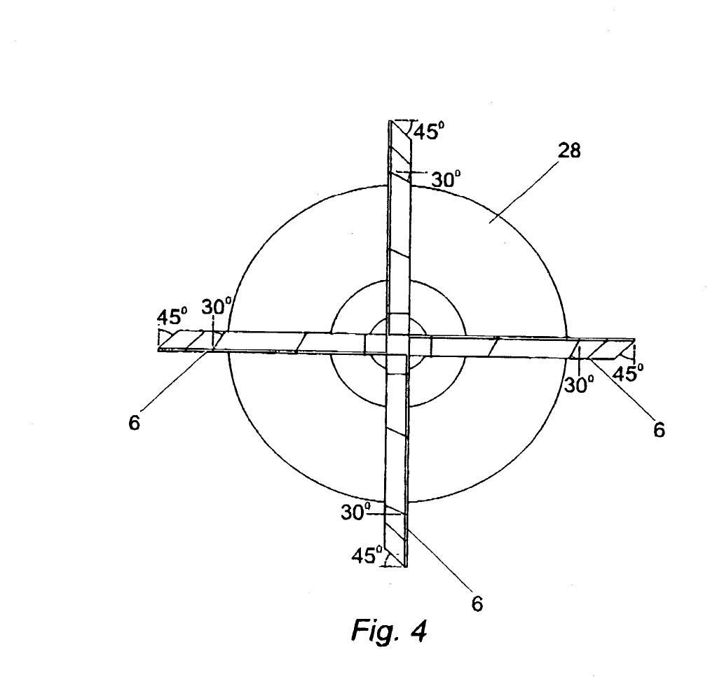

FIG. 4 is a view of the fixing of FIG. 1 from its leading end;

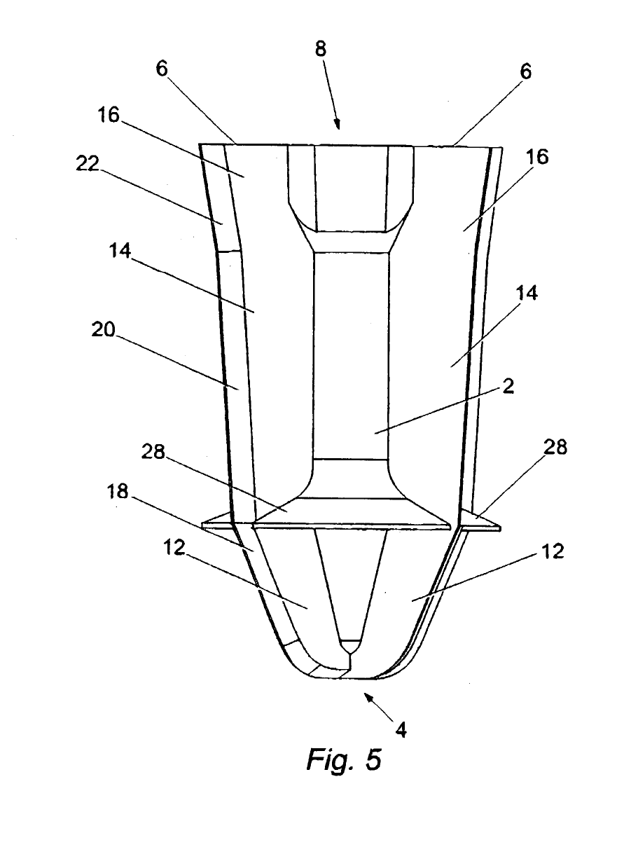

FIG. 5 is a plan view of the fixing of FIG. 1 in the direction of arrow A; and

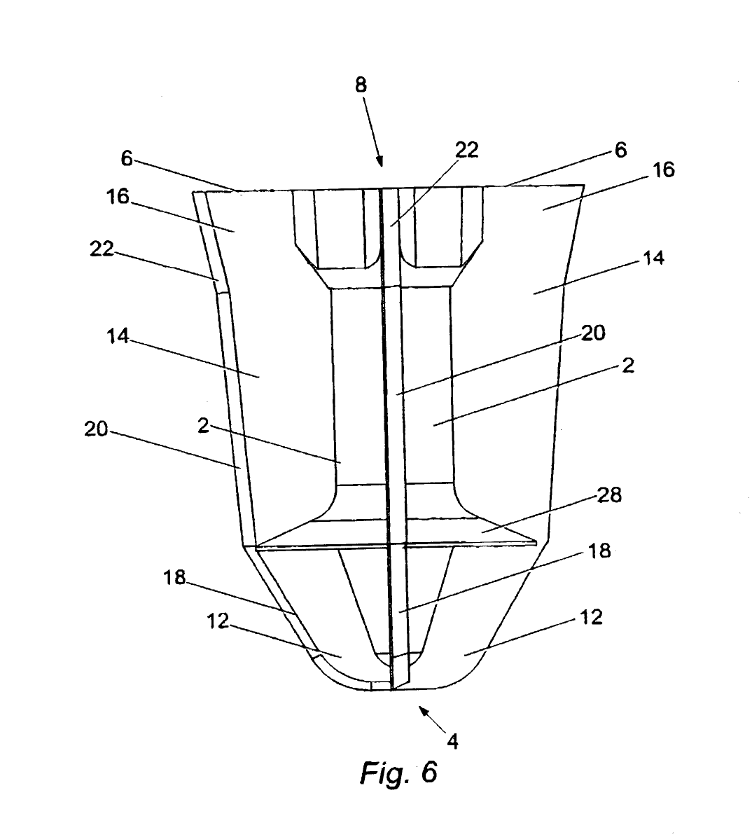

FIG. 6 is a plan view of the fixing of FIG. 1 in the direction to arrow B.

Referring to the drawings and initially to FIG. 1 there is provided a fixing according to the invention indicated generally by the reference numeral 1.

The fixing 1 comprises a central body 2, generally in the shape of a cylindrical core having a central longitudinal axis indicated by the line L—L, and tapering at a leading end 4 of the fixing 1 to a tip 5. The cylindrical body 2 has four fins 6 projecting laterally therefrom, perpendicular to the longitudinal axis L—L and extending along the length of the cylindrical body 2 from a trailing end 8 of the fixing 1 where the fins 6 are equi-spaced apart to the leading end 4 of the fixing 1 where the fins 6 converge at the tip 5. The fins 6 slope along the length of the cylindrical body 2 from the trailing end 8 of the fixing 1 to the tip 5. The sloping gradient of each fin 6 varies along its length.

Each fin 6 has a forward cutting portion 12, a mid reaming portion 14 and a rear portion 16.

The forward cutting portion 12 slopes from the leading end 4 of the fixing 1 in an outwardly direction from the cylindrical body 2. The cutting portion 12 of each fin 6 initially slopes to form an arcuate path and then continues to slope with a constant gradient to the mid reaming portion 14.

The mid reaming portion 14 of the fin 6 slopes in an outwardly direction from the cylindrical body 2 to the rear portion 16 of the fin 6. The gradient of the mid reaming portion 14 is less than that of the cutting portion 12. The rear portion 16 then slopes to the trailing end 8 of the fixing 1 at a gradient intermediate that of the cutting portion 12 and mid reaming portion 14.

The cutting portion 12, mid reaming portion 14 and rear portion 16 have a cutting edge 18, 20 and 22 respectively remote from the cylindrical body 2. In this embodiment, the cutting edge 18 has a sharpness defined by an angle of approximately 30° with an opposing face of the cutting portion 12. The cutting edges 20 and 22 have a sharpness defined by an angle of approximately 45° with an opposing face of the mid reaming portion 14 and rear portion 16 respectively.

The cylindrical body 2 is hollowed along a portion of its length and has a circular shaped opening 24 at the trailing end 8 of the fixing 1 for receiving a fixing screw. The trailing end 8 of the fixing 1 has grooves 26 extending radially from the opening 24 for receiving a screwdriver head.

The fixing 1 further includes a forward circular skirt 28 extending outwardly from the cylindrical body 2 and spanning between the fins 6 of the forward cutting portion 12 at the junction Y which is defined by the change in gradient of the fins 6 between the cutting portion 12 and mid reaming portion 14. The radius of the skirt 28 falls short of the cutting edge 18 at the cutting portion 12.

In this embodiment the fixing 1 is a zinc alloy.

In use, the fixing 1 is inserted into an existing hole 30 (not shown) in a wall of frangible material, for example plasterboard, normally to a depth approaching that of the forward cutting portion 12 using a flat or cross head screwdriver which fits into the grooves 26. The existing hole 30 has typically eroded so as to be out of round and no longer capable of firmly supporting a fitting attached to the wall through a screw and conventional fixing.

The fixing 1 is gently but firmly pushed into the wall while rotating the screwdriver. As the fins 6 raper outwardly of the cylindrical body 2 from the leading end 4 to the trailing end 8 of the fixing 1, the rotating action of the cutting portion 12 enlarges the existing hole 30 as the fixing 1 is being inserted into the hole 30. As insertion of the fixing 1 into the hole 30 is continued, the cutting action of the cutting portion 12 is followed by a reaming action of the mid reaming portion 14 which smoothes the walls of the now enlarged hole 30. The taper of the fins 6 at the mid reaming portion 14 is of a lesser gradient than that of the taper of the forward cutting portion 12 and as such the reaming action of the mid reaming portion 14 provides a slight further enlargement of the hole 30.

The taper of the mid reaming portion 14 helps ease the process of inserting the fixing 1 into the hole 30 and improves its smoothing action to create smooth, even walls of the hole 30. The taper of the mid reaming portion 14 also controls the rate at which the fixing 1 is inserted into the hole 30 and provides resistance to the fixing 1 being pushed right through the wall.

Once the fixing 1 has been inserted into the hole 30 up to the junction x of the mid reaming portion 14 and the rear portion 16, the fixing 1 is hammered into the wall by hitting the trailing end 8 of the fixing 1 with a conventional hammer, for example. The rear portion 16 of the fins 6 cuts into the wall about the hole 30 providing resistance to the rotation of the fixing 1 while safely securing it within the wall.

When insertion of the fixing 1 into the plasterboard wall has been completed the forward Skirt 28 lies outside and adjacent the rear face of the plasterboard wall. Furthermore, the four fins 6 subdivide the passageway of the hole 30 in the plasterboard wall into four passageways, and this is shown most clearly by the different hatched portions C, D, E and F in FIG. 3.

A non-shrinking, hard-setting filler material such as PLASTIC WOOD™ or POLYFILLA™, is then injected at the trailing end 8 of the fixing 1 to fill the passageways C, D, E and F. Once the filler material has hardened it further prevents the fixing 1 from rotating and firmly secures it within the hole 30 of the plasterboard wall. The filler material also extends through the passageways C, D, E and F beyond the rear surface of the wall and is then directed laterally by the forward skirt 28. The filler material on hardening anchors the skirt 28 to the rear surface of the plasterboard wall thus further securing the fixing 1 within the hole 30.

Items such as shelves can then be attached to the plasterboard wall by inserting a conventional screw through a bracket for supporting the shelf and into the opening 24 of the fixing 1 thus securing the bracket between the fixing 1 and the screw.

It will be appreciated that the fixing 1 can be produced in a range of sizes. Typically, the diameter of the fixing 1 can range from 10 mm to 50 mm. Generally, the larger the fixing 1 the more fins 6 that are required to prevent rotation of the fixing 1 within the hole 30 and to securely fix it therein. For smaller diameters of the fixing 1, fewer fins 6 are required both for stability and to provide a passageway large enough to allow adhesive to be injected into the passageway.

It will also be appreciated that the fixing 1 could incorporate a rear annular skirt attached to the rear portion 16 of the fins 6 remote from the mid reaming portion 18, the annular skirt extending outwardly of the cylindrical body 2. When the fixing 1 is fully inserted into the hole 30, the annular skirt would lie flush with the outer surface of the plasterboard wall preventing further insertion of the fixing 1 into the hole 30. The annular skirt would also provide a flat surface on the trailing end 8 of the fixing 1 to improve and ease the action of hammering the fixing 1 into the plasterboard wall.

It will be further appreciated that the filler material may be dispensed through a nozzle of a corresponding cross sectional shape to that of the passageway for ease of injection of the filler material into the passageway.

It will also be appreciated that the fixing may be made from any suitable material, for example steel, zinc or zinc alloy, or a composite material, for example glass filled nylon.

It will be appreciated that the cutting edge 18 may have a sharpness defined by any suitable angle. Typical suitable angles range between 15° and 45° with an opposing face of the forward cutting portion 12.

It will also be appreciated that the cutting edges 20 and 22 may have a sharpness defined by any suitable angle. Typical suitable angles range between 30° and 60° with an opposing face of the mid reaming portion 14 and rear portion 16 respectively.

Modifications and improvements may be made to the foregoing within the scope of the present invention.

1. A fixing having a body, a cutting edge extending laterally from the body for reaming a hole in a wall of material, said body having means for engaging a tool for rotating the fixing, and a generally axial recess in the body for receiving a a screw.

2. A fixing as claimed in claim 1, wherein the fixing has at least two fins projecting laterally from the body.

3. A fixing as claimed in claim 2, wherein each fin has a cutting edge.

4. A fixing as claimed in claims 2 or 3, wherein the fins converge to a leading end of the body.

5. A fixing as claimed in any of claims 2 to 4, wherein the fins extend longitudinally of the body and each fin has a forward cutting portion, a mid reaming portion and a rear portion.

6. A fixing as claimed in any preceding claim, wherein the body has means for resisting rotation of the fixing once fully inserted into the wall.

7. A fixing as claimed in claim 6, wherein the resisting means is the rear portion of the fins.

8. A fixing as claimed in any preceding claim, wherein the fixing has a longitudinal recess which, in use, forms with the reamed portion of the hole of the wall a passageway at least one end of which is open for receiving a filler material.

9. A fixing as claimed in claim 8, wherein the fins, the body and said reamed portion of the hole of the wall define said passageway for receiving the filler material.

10. A fixing as claimed in claims 8 or 9, wherein the filler material has adhesive properties and bonds with the material of the wall.

11. A fixing as claimed in any of claims 8 to 10, wherein the filler material is a non-shrinking curable polymer.

12. A fixing as claimed in any of claims 8 to 11, wherein the filler material is PLASTIC WOOD™ or POLYFILLA™.

13. A fixing as claimed in any of claims 5 to 12, wherein the forward cutting portion, mid reaming portion and rear portion caper towards the leading end of the fixing.

14. A fixing as claimed in any of claims 5 to 13, wherein the forward cutting portion, mid reaming portion and trailing portion each have a cutting edge.

15. A fixing as claimed in claim 14, wherein the sharpness of the cutting edge of the cutting portion is defined by an angle of between 15° and 45° with an opposing face of the cutting portion.

16. A fixing as claimed in claims 14 or 15, wherein the sharpness of the cutting edge of the mid reaming portion and rear portion is each defined by an angle of between 30° and 60° with an opposing face of the mid reaming portion and rear portion respectively.

17. A fixing as claimed in any of claims 13 to 16, wherein the gradient of the taper of the rear portion is greater than the gradient of the taper of the mid reaming portion.

18. A fixing as claimed in any of claims 5 to 17, wherein the fixing has an anchoring member at a junction of the forward cutting portion and the mid reaming portion.

19. A fixing as claimed in claim 18, wherein the anchoring member is a skirt extending outwardly from the body and spanning between the fins at the junction of the forward cutting portion and the mid reaming portion.

20. A fixing as claimed in claim 19, wherein the skirt has a periphery which falls short of the cutting edge of the cutting portion.

21. A fixing as claimed in any of claims 5 to 20, wherein the fixing has a stop member depending from the fine at the rear portion remote from the mid reaming portion.

22. A fixing as claimed in claim 21, wherein the stop member is an annular shaped skirt extending outwardly from the fins.

23. A fixing as claimed in any preceding claim wherein the diameter of the fixing is in the range of 10 mm to 50 mm.

24. A fixing as claimed in any preceding claim wherein the fixing is of a zinc or a zinc alloy material.

25. A fixing as claimed in any preceding claim, wherein the fixing is of a composite material.

26. A fixing as claimed in any of claims 8 to 25, wherein the filler material is dispensed through a nozzle of a corresponding cross sectional shape to that of the passageway. A method of repairing a hole in a wall of frangible material comprising the steps of, inserting the fixing into the hole to a depth approaching that of the cutting portion 12, continuing to insert the fixing into the hole up to the junction of the mid reaming portion and rear portion by applying pressure to the fixing in the direction of the hole while at the same time rotating the fixing, hammering the rear portion of the fixing into the wall and injecting filler material into the passageway.
